(19) United States
(12) Patent Application Publication
(10) Pub. No.: US 2026/0343324 A1
(43) Pub. Date: Oct. 29, 2026

(54) OPTIMAL POWER SPECTRAL DENSITY (PSD) FOR PUNCTURED OR UNPUNCTURED BANDWIDTH

(71) Applicant: Cisco Technology, Inc., San Jose, CA (US)

(72) Inventors: Brian D. Hart, Sunnvale, CA (US); Sachin D. Wakudkar, St-Sulpice (CH); Arya Fallahi, Zürich (CH)

(73) Assignee: Cisco Technology, Inc., San Jose, CA (US)

(21) Appl. No.: 19/189,424

(22) Filed: Apr. 25, 2025

(51) Int. Cl. H04W 28/20; H04L 5/00; H04W 52/30; H04W 72/044

(52) U.S. Cl. CPC H04W 28/20; H04L 5/0039; H04W 52/30; H04W 72/0473

(57) ABSTRACT

Optimal Power Spectral Density (PSD) for unpunctured bandwidth may be determined. First, a plurality of (un)punctured modes that can be signaled in a maximum bandwidth of interest may be identified. Next, a plurality of grades may be determined where each of the plurality of grades respectively corresponds to each of the plurality of (un)punctured modes. Then a one of the plurality of (un)punctured modes that is associated with a best of the plurality of grades may be selected.

### TECHNICAL FIELD

The present disclosure relates generally to determining optimal Power Spectral Density (PSD) for punctured or unpunctured bandwidth.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired and optionally switched network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for determining optimal Power Spectral Density (PSD) for unpunctured bandwidth;

FIG. 2 is a flow chart of a method for determining optimal PSD for unpunctured bandwidth;

FIG. 3 illustrates a Transmit (TX) PSD mask intersecting an Automated Frequency Coordination (AFC) frequency response;

FIG. 4 illustrates a TX PSD mask intersecting an AFC frequency response;

FIG. 5 illustrates a TX PSD mask being no higher than an AFC frequency response; and

FIG. 6 is a block diagram of a computing device.

### DETAILED DESCRIPTION

### OVERVIEW

Optimal Power Spectral Density (PSD) for unpunctured bandwidth may be determined. First, a plurality of punctured and punctured modes that can be signaled in a maximum bandwidth of interest may be identified. Next, a plurality of grades may be determined where each of the plurality of grades respectively corresponds to each of the plurality of punctured and punctured modes. Then a one of the plurality of punctured and punctured modes that is associated with a best of the plurality of grades may be selected.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Low Power Indoor (LPI) and Standard Power (SP) are two classes of Wi-Fi APs that differ in their power levels and how they operate. LPI APs may be designated for indoor use and operate at lower power levels. The AP class may be so constrained to minimize interference with incumbents not within the same building. LPI APs may be required to have permanently attached antennas, be not weatherized and be powered by a wired connection, and may be subject to additional conditions. SP APs may operate indoors or outdoors at full power. They may be designed to provide extended coverage and range, making them suitable for larger indoor spaces and outdoor deployments. SP APs may be controlled by an Automated Frequency Coordination (AFC) System to mitigate interference with other services (i.e., incumbents).

In the case of a channel-based response, AFC may share a list of available channels and allowed Effective Isotropic Radiated Power (EIRP) levels with a Wireless Local Area Network controller (WLC) or AP. In response, the permitted EIRP may be aggregated over the channel bandwidth. Furthermore, the channel-based response may take into account adjacent channel protection (i.e., all the power in the Radio Local Area Network’s (RLAN’s) adjacent band that lies inside Fixed Services (FS) Receive (Rx) band is included in the “interference” (of Interference-to-Noise (I/N) ratio)).

With Wi-Fi 7, preamble puncturing is allowed, together with Orthogonal Frequency Division Multiple Access (OFDMA) or Multiple RUs (MRUs) so devices’ PHY Protocol Data Units (PPDUs) may be entirely punctured on a channel where interference may be present and use the rest of the bandwidth for data communication to get the most out of the wider channel. The puncturing may be defined or allowed at 20 MHz granularity for example. In some locations, there may not be enough wide bandwidth unpunctured channels available due to the presence of incumbents, so puncturing may be a desirable option, or an option more desirable than bandwidth reduction. Bandwidth reduction is normally not called puncturing although the difference can be subtle: for instance, for a bandwidth of 80 MHz represented as 4x20 MHz channels or “BBBB”, then “Ynnn”, “nYnn”, “nnYn”, “nnnY”, “YYnn”, “nnYY” are described as bandwidth reduced (where Y = occupied (used to convey information) and n = not occupied, whereas “YnYn”, “YnnY”, “nYnY”, “nYYn” “YYYn”, “YYnY”, “YnYY”, and “nYYY” are described as punctured. Put another way, Wi-Fi begins with 20 MHz channels then iteratively doubles them via bonding a pair of adjacent channels (in a constrained pattern). Bandwidths that do not conform to this bonding process are labelled as punctured.

However, the channel-based response may not be efficient for punctured channels. This may be due to the multitude of potential puncturing options. The AFC may also support a frequency-based response where the AFC engine communicates the permitted Power Spectral Density (PSD) EIRP level at a 1 MHz granularity for example. A frequency-based response may be used to ascertain what punctured channels are permitted and at what power levels. Because the frequency-based response may not compute or incorporate adjacent channel protection, the processing may be performed by the WLC/AP. Accordingly, embodiments of the disclosure may provide a process to optimize the available occupied (unpunctured) bandwidth and EIRP PSD that stays within regulatory limits (e.g., United States (US) Federal Communications Commission (FCC)), wherein a metric of goodness is defined for each punctured option.

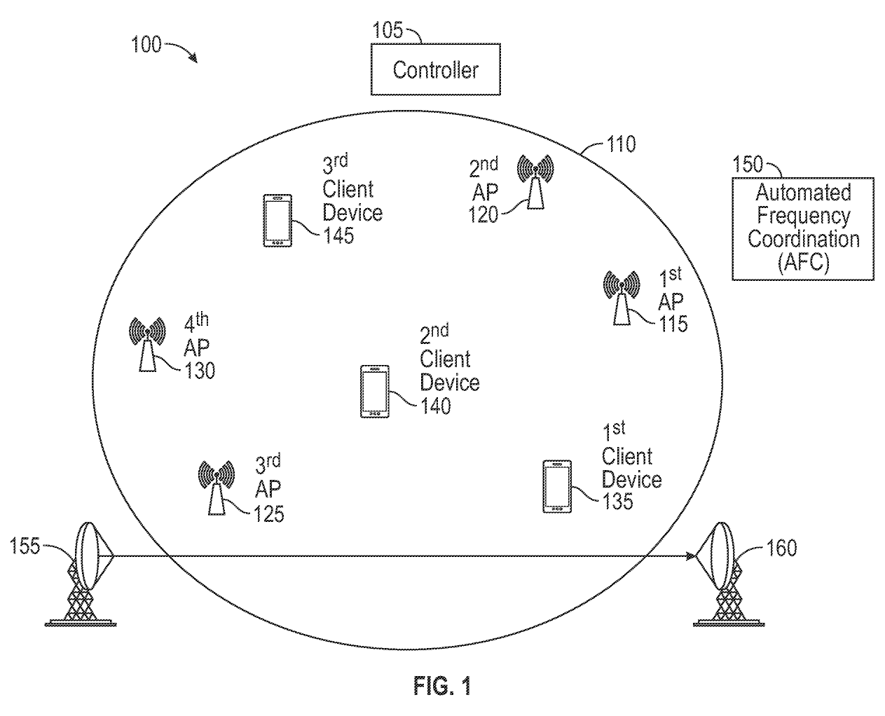

FIG. 1 shows an operating environment 100 for determining optimal Power Spectral Density (PSD) for punctured and unpunctured bandwidth. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125, and a fourth AP 130. The plurality of APs may provide wireless network access to a plurality of client devices as they move within coverage environment 110. The plurality of client devices may comprise, but are not limited to, a first client device 135, a second client device 140, and a third client device 145. Instances of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with standards such as, but not limited to, the Institute of Electrical and Electronics Engineers (IEEE) 802.11 standard for example.

The plurality of APs and the plurality of client devices may use Multi-Link Operation (MLO) where they simultaneously transmit and receive across different channels typically in different bands by establishing two or more links to two or more AP radios in the same AP device. These bands may comprise, but are not limited the 2.4 GHz band, the 5 GHz band, the 6 GHz band, the 60 GHz band and the light/infra-red/ultra-violet band.

Controller 105 may comprise a Wireless Local Area Network controller (WLC) and may provision and control coverage environment 110 (e.g., a WLAN). Controller 105 may allow first client device 135, second client device 140, and third client device 145 to join coverage environment 110. In some embodiments the controller functionality may reside in one AP or may be distributed across multiple (e.g. all) APs. In some embodiments of the disclosure, portions of the functionality of the controller 105 may be implemented by a Digital Network Architecture Center (DNAC) controller (i.e., a Software-Defined Network (SDN) controller) that may configure information for coverage environment 110 in order to determine optimal PSD for punctured and unpunctured bandwidth.

In order for unlicensed devices (e.g., Wi-Fi devices such as client devices and APs) to work with the licensed users and/or incumbents already occupying a band (e.g., the 6 GHz band), AFC was established. AFC is a spectrum use coordination system. For example, because the 6 GHz band was already occupied by incumbent users, such as fixed satellite providers, restrictions may be placed on the Wi-Fi devices looking to transmit in this band. To avoid potential interference with existing 6 GHz incumbents, AFC may impose two types of device classifications with different transmit power rules for devices operating on the band: i) low power APs that are constrained to be used indoor only and ii) standard power APs that may be used indoors and outdoors.

As shown in FIG. 1, AFC 150 may provide spectrum use coordination for coverage environment 110 and beyond. A transmitter 155 and a receiver 160 may comprise a licensed FS incumbent user. First AP 115, second AP 120, third AP 125, and fourth AP 130 may comprise unlicensed devices. AFC 150 may coordinate spectrum use between the incumbent and unlicensed devices to avoid potential interference to the incumbent devices due to emissions arising in the coverage environment 110.

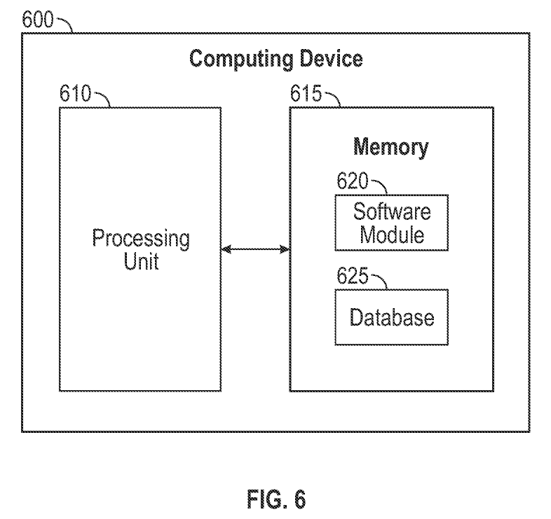

The elements described above of operating environment 100 (e.g., controller 105, first AP 115, second AP 120, third AP 125, fourth AP 130, first client device 135, second client device 140, or third client device 145) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

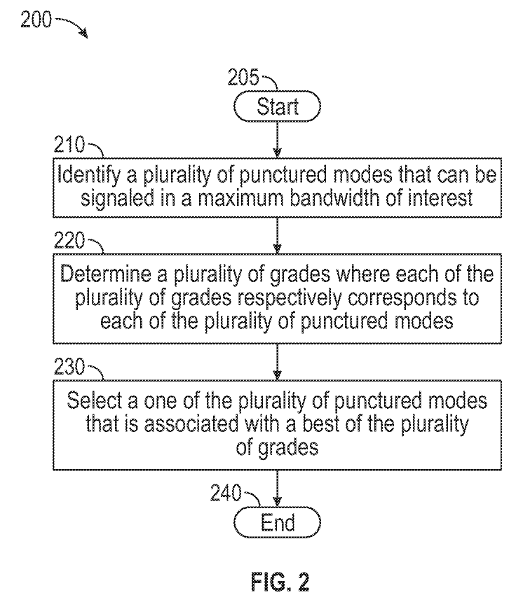

FIG. 2 is a flow chart setting forth the general stages involved in a method 200 consistent with embodiments of the disclosure for determining optimal PSD for punctured and unpunctured bandwidth. Method 200 may be implemented using computing device 600 as described in more detail below with respect to FIG. 6. Computing device 600 may be embodied by first AP 115 or controller 105 for example. Ways to implement the stages of method 200 will be described in greater detail below.

Method 200 may begin at starting block 205 and proceed to stage 210 where computing device 600 may identify a plurality of punctured and unpunctured modes that can be signaled in a maximum bandwidth of interest. For example, the maximum bandwidth of interest may comprise, but is not limited to, 80 MHz with four 20 MHz channels (e.g., a channel list of 1, 5, 9, and 13. With this example, the signal-able (i.e., optionally punctured) channel bandwidths may comprise the plurality of punctured and unpunctured modes (e.g., 11 punctured and unpunctured modes) as listed as follows: 1, 5, 9, 13, 1+5, 9+13, 1+5+9, 1+5+13, 1+9+13, 5+9+13, and 1+5+9+13. Other maximum bandwidths of interest, channel bandwidth, and punctured modes may exist and are not limited to the aforementioned. As well, the plurality of punctured and unpunctured modes may include some subset of the list of all possible or defined/signalable punctured and unpunctured modes.

From stage 210, where computing device 600 identifies the plurality of punctured and unpunctured modes that can be signaled in the maximum bandwidth of interest, method 200 may advance to stage 220 where computing device 600 may determine a plurality of grades where each of the plurality of grades respectively corresponds to each of the plurality of punctured and unpunctured modes. For example, a Transmit (TX) Power Spectral Density (PSD) mask for each channel in the maximum bandwidth of interest may be determined. The TX PSD mask may comprise an IEEE TX PSD mask and/or may be one that is allowed by a regulator (e.g., United States (US) Federal Communications Commission (FCC)). Then a plurality of maximum allowed TX PSDs may be calculated respectively corresponding to the plurality of punctured and unpunctured modes using the TX PSD mask and an Automated Frequency Coordination (AFC) frequency response.

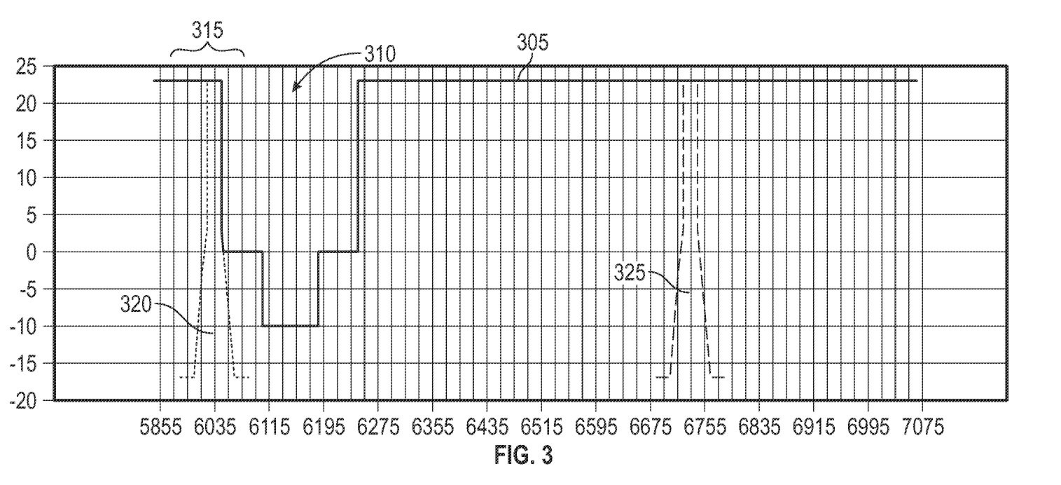

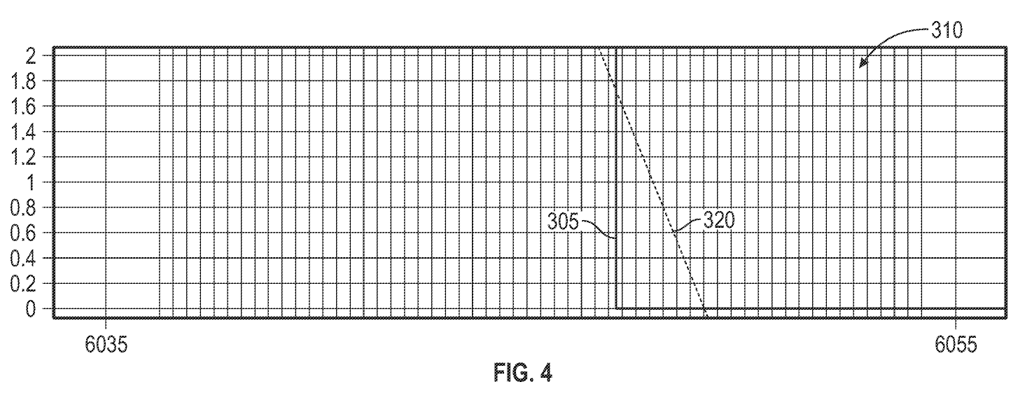

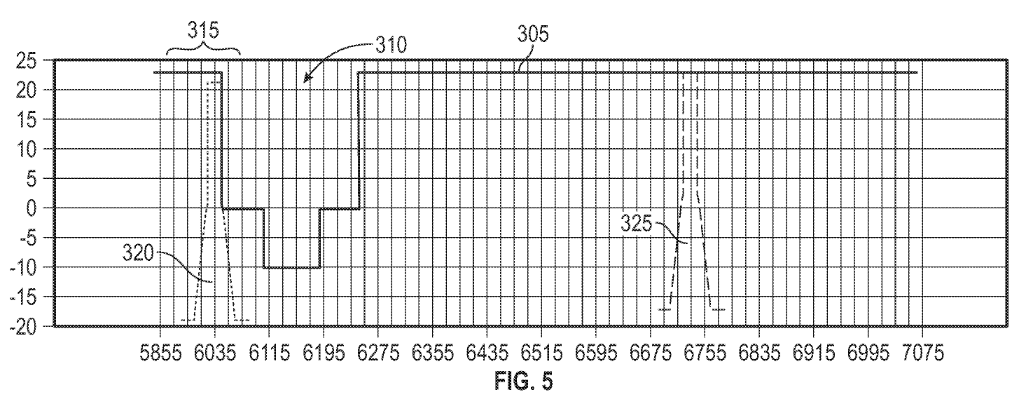

FIG. 3 illustrates a sample AFC frequency response 305 that has some AFC restrictions 310 within 6000-6300 MHz for example. A maximum bandwidth of interest 315 may comprise 20, 40, 80, 160 or 320 MHz as described above, or another bandwidth such as 480 or 640 MHz. FIG. 3 further illustrates a TX PSD mask 320 for a 20 MHz channel width within maximum bandwidth of interest 315 with maximum EIRP PSD of 23 dBm/MHz. TX PSD mask 320 may be taken at a given center frequency and slid up/down (e.g., parallel to the y/dBm axis) until it touches, but nowhere exceeds, AFC frequency response 305. With this center frequency, TX PSD mask 320 may not cross AFC frequency response 305. Zooming into FIG. 3, FIG. 4 illustrates a need to lower the EIRP by at least 1.8 dB to ensure that TX PSD mask 320 does not exceed AFC frequency response 305, so then at this channel in this example, up to 23 – 1.8 = 21.2 dBm/MHz may be allowed. FIG. 5 illustrates lowering (i.e., sliding down) the EIRP by 1.8 dB to ensure that TX PSD mask 320 falls below AFC frequency response 305. Another TX PSD mask 325 may correspond to another channel in another maximum bandwidth of interest. Because AFC restrictions may not be present in this portion of the spectrum, this TX PSD mask 325 may not be lowered. In other words, because TX PSD mask 325 does not cross AFC frequency response 305, up to 23 dBm/MHz EIRP may be allowed for this 20 MHz channel in this example.

Generalizing the aforementioned lowering of TX PSD masks for the punctured and unpunctured channels (e.g., made up of multiple 20 MHz components) within the maximum bandwidth of interest for each of the plurality of punctured and unpunctured modes, a first embodiment may have a flat PSD across all 20 MHz components (i.e., channels). In other words, all the TX PSD masks for each of the plurality of punctured and unpunctured modes are lowered by the same magnitude. In another embodiment, each of the 20 MHz components (i.e., channels) may slide up/down independently. For example, the PSD over channel 1 may be greater than channel 5 that may be greater than channel 13. Under IEEE TX PSD rules (e.g., that may be allowed by regulators), it may be the max of each TX PSD that counts (not the sum) so the sliding may be independent. In this second embodiment, if the sum TX PSD mask needs to be considered, a good heuristic to limit the plurality of punctured and punctured channels that need to be processed may be to have as flat a spectrum as possible. Then start with the weakest 20 MHz, subtract it from the AFC mask in the power domain, and repeat for the next weakest 20 MHz against the subtracted-AFC-mask until all 20 MHz channels are processed.

Determining the plurality of grades may further comprise determining a plurality of metrics of goodness respectively based on the plurality of maximum allowed TX PSDs. For example, the plurality of metrics of goodness respectively comprise the plurality of grades. Each of the plurality of metrics of goodness may be defined, for example as: a (first) function of characteristics such as i) the total power (also known as sum power, without regard to BW), ii) the number of 20 MHz channels without regard to power (also known as occupied bandwidth), iii) the number of 20 MHz channels with EIRP above a threshold, iv), the expected throughput given the available power, v) some weighted sum of these such as “1000000 * iii) + i)” or vi) some hybrid of these such as “iii) as a primary grade then i) as a secondary (tie-breaking) grade”, etc. Assume these characteristics reflect the properties of the maximum bandwidth. As well, since a (punctured) 320 MHz bandwidth has a primary (punctured) 160 MHz bandwidth which in turn has a primary (punctured) 80 MHz bandwidth which in turn has a primary (punctured) 80 MHz bandwidth which in turn has a primary 40 MHz with in turn has a primary 20 MHz, the grade might be based on a (second) function of these characteristics calculated for each of the allowed or applicable bandwidths. The second function might be a simple sum of the first functions, for each of the relevant bandwidths (the maximum bandwidth and each primary bandwidth therein).

Once computing device 600 determines the plurality of grades where each of the plurality of grades respectively corresponds to each of the plurality of punctured and unpunctured modes in stage 220, method 200 may continue to stage 230 where computing device 600 may select a one of the plurality of punctured and unpunctured modes that is associated with a best of the plurality of grades. For example, any of the aforementioned metrics of goodness may be used to calculate the plurality of grades and then the punctured and unpunctured mode that is associated with a best or a near-best metric of goodness may be selected. Once computing device 600 selects the one of the plurality of punctured and unpunctured mode that is associated with the best of the plurality of grades in stage 230, method 200 may then end at stage 240.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for determining optimal PSD for unpunctured bandwidth as described above with respect to FIG. 2. Computing device 600, for example, may provide an operating environment for controller 105, first AP 115, second AP 120, third AP 125, fourth AP 130, first client device 135, second client device 140, or third client device 145. Controller 105, first AP 115, second AP 120, third AP 125, fourth AP 130, first client device 135, second client device 140, and third client device 145 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
identifying a plurality of punctured and unpunctured modes that can be signaled in a maximum bandwidth of interest;
determining a plurality of grades where each of the plurality of grades respectively corresponds to each of the plurality of punctured and unpunctured modes; and
selecting a one of the plurality of punctured and unpunctured modes that is associated with a best of the plurality of grades.

2. The method of claim 1, wherein determining the plurality of grades further comprises calculating a Transmit (TX) Power Spectral Density (PSD) mask for each channel for the maximum bandwidth of interest and for primary channels within the maximum bandwidth of interest.

3. The method of claim 2, wherein the TX PSD mask is one that is allowed by a regulator.

4. The method of claim 2, wherein the TX PSD mask is an Institute of Electrical and Electronics Engineers (IEEE) TX PSD mask.

5. The method of claim 2, wherein determining the plurality of grades further comprises calculating a plurality of maximum allowed TX PSDs respectively corresponding to the plurality of punctured and unpunctured modes using the TX PSD mask and an Automated Frequency Coordination (AFC) frequency response.

6. The method of claim 5, wherein determining the plurality of grades further comprises determining a plurality of metrics of goodness respectively based on the plurality of maximum allowed TX PSDs and for the primary channel within the maximum bandwidth of interest.

7. The method of claim 6, wherein the plurality of metrics of goodness respectively comprise the plurality of grades.

8. A system comprising:
a memory storage; and
a processing unit coupled to the memory storage, wherein the processing unit is operative to:
identify a plurality of punctured and unpunctured modes that can be signaled in a maximum bandwidth of interest;
determine a plurality of grades where each of the plurality of grades respectively corresponds to each of the plurality of punctured and unpunctured modes; and
select a one of the plurality of punctured and unpunctured modes that is associated with a best of the plurality of grades.

9. The system of claim 8, wherein the processing unit being operative to determine the plurality of grades further comprises the processing unit being operative to calculate a Transmit (TX) Power Spectral Density (PSD) mask for each channel for the maximum bandwidth of interest and for primary channels within the maximum bandwidth of interest.

10. The system of claim 9, wherein the TX PSD mask is one that is allowed by a regulator.

11. The system of claim 9, wherein the TX PSD mask is an Institute of Electrical and Electronics Engineers (IEEE) TX PSD mask.

12. The system of claim 9, wherein the processing unit being operative to determine the plurality of grades further comprises the processing unit being operative to calculate a plurality of maximum allowed TX PSDs respectively corresponding to the plurality of punctured and unpunctured modes using the TX PSD mask and an Automated Frequency Coordination (AFC) frequency response.

13. The system of claim 9, wherein the processing unit being operative to determine the plurality of grades further comprises the processing unit being operative to determine a plurality of metrics of goodness respectively based on the plurality of maximum allowed TX PSDs and wherein the plurality of metrics of goodness respectively comprise the plurality of grades.

14. A non-transitory computer-readable medium that stores a set of instructions which when executed perform a method executed by the set of instructions comprising:
identifying a plurality of punctured and unpunctured modes that can be signaled in a maximum bandwidth of interest;
determining a plurality of grades where each of the plurality of grades respectively corresponds to each of the plurality of punctured and unpunctured modes; and
selecting a one of the plurality of punctured and unpunctured modes that is associated with a best of the plurality of grades.

15. The non-transitory computer-readable medium of claim 14, wherein determining the plurality of grades further comprises calculating a Transmit (TX) Power Spectral Density (PSD) mask for each channel for the maximum bandwidth of interest and for primary channels within the maximum bandwidth of interest.

16. The non-transitory computer-readable medium of claim 15, wherein the TX PSD mask is one that is allowed by a regulator.

17. The non-transitory computer-readable medium of claim 15, wherein the TX PSD mask is an Institute of Electrical and Electronics Engineers (IEEE) TX PSD mask.

18. The non-transitory computer-readable medium of claim 15, wherein determining the plurality of grades further comprises calculating a plurality of maximum allowed TX PSDs respectively corresponding to the plurality of punctured and unpunctured modes using the TX PSD mask and an Automated Frequency Coordination (AFC) frequency response.

19. The non-transitory computer-readable medium of claim 18, wherein determining the plurality of grades further comprises determining a plurality of metrics of goodness respectively based on the plurality of maximum allowed TX PSDs.

20. The non-transitory computer-readable medium of claim 19, wherein the plurality of metrics of goodness respectively comprise the plurality of grades.
